(19) United States
(12) Patent Application Publication
(10) Pub. No.: US 2025/0321676 A1
(43) Pub. Date: Oct. 16, 2025

(54) METHODS AND APPARATUS TO MANAGE MEMORY MOVEMENT

(71) Applicant: Intel Corporation, Santa Clara, CA (US)

(72) Inventors: Zion Siu-On Kwok, Burnaby (CA); Jing Ling, Milpitas, CA (US)

(73) Assignee: Intel Corporation, Santa Clara, CA (US)

(21) Appl. No.: 19/251,548

(22) Filed: Jun. 26, 2025

(51) Int. Cl. G06F 3/06

(52) U.S. Cl. CPC G06F 3/0611; G06F 3/0646; G06F 3/0673

(57) ABSTRACT

Systems, apparatus, articles of manufacture, and methods are disclosed to implement memory sparing. An example memory controller includes first logic circuitry to: determine a first bank index for a bank of a memory that is to be moved; and determine if a first row index hash of an element in the bank of memory matches the first bank index; and second logic circuitry to: when the first row index hash matches the first bank index, move the element to a reserved row of the memory in the memory based on the first row index; and when the first row index hash does not match the first bank index, move the element to a bank in the reserved row that has a second bank index based on the first row index.

### BACKGROUND

In computing systems, it is sometimes desirable to move data from one portion of memory to another. For example, when a portion of memory is determined to be faulty, the faulty portion of memory may be flagged as faulty and the data stored in that portion of the memory may be moved to another location. This process, known as “sparing,” is one reason that elements in memory may be moved or relocated.

### BRIEF DESCRIPTION OF THE DRAWINGS

FIG. 1 is a block diagram of an example environment in which an example memory controller operates to move elements in memory.

FIG. 2 is a block diagram of an example implementation of the sparing circuitry of FIG. 1.

FIG. 3 is a flowchart representative of example machine readable instructions and/or example operations that may be executed, instantiated, and/or performed by example programmable circuitry to implement the sparing circuitry of FIG. 2.

FIG. 4 is a flowchart representative of example machine readable instructions and/or example operations that may be executed, instantiated, and/or performed by example programmable circuitry to implement the sparing circuitry of FIG. 2.

FIGS. 5-6 illustrate an example movement of elements in memory that may be performed/caused by the sparing circuitry of FIG. 2.

FIG. 7 is a block diagram of an example processing platform including programmable circuitry structured to execute, instantiate, and/or perform the example machine readable instructions and/or perform the example operations of FIGS. 3-4 to implement the sparing circuitry 108 of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 3-4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Methods and apparatus disclosed herein perform memory sparing or movement for other reasons in an efficient manner. For example, methods and apparatus disclosed herein may perform sparing without the need for multiplications, divisions, or modulo operations, which facilitates implementations that utilize fewer gate count and have lower latency. Methods and apparatus disclosed herein may utilize a reserved area in memory as the destination for spared memory (e.g., a reserved area in a single bank of memory among a plurality of banks). For example, methods and apparatus may utilize one spare bank per die, one spare bank per stack identifier, one spare bank per pseudochannel, one spare bank per channel, one spare bank per stack identifier (SID) across two pseudochannels on one channel, etc.

Methods and apparatus disclosed herein move a column of memory (e.g., a bank index) into reserved rows. When moving the column, the destination address is calculated based on the row address of the element. However, when the destination address would be in the column of memory to be moved, the destination address is set to a different location (e.g., to an address at the end of the reserved rows).

In the examples disclosed herein, a bank of memory is indexed by a 1-bit pseudochannel index (PCH) and a 4-bit bank index (B3:B0), which are concatenated into a 5-bit signal: {PCH, B3:B0}. When the stack, pseudochannel, and bank address bits are converted into a system address, the row address bits are placed as the most significant bits. In the examples herein, there is a power of 2 number of stacks, pseudochannels and banks, and a non-power of 2 number of rows. In such an example, the row address is 15 bits. When 1/32 capacity is reserved and row address (RA) RA14:RA13 only has ¾ values, the 7 most significant bits RA14:RA8 are used to calculate a remapped address when bank sparing is enabled. For generality, we rename RA14:RA8 as the upper bits, U6:U0. While particular address arrangements are used herein, any other address arrangements may be utilized. For example, while a reserved area in the examples is in the last rows the memory, any other location may be utilized (e.g., the first rows of the memory).

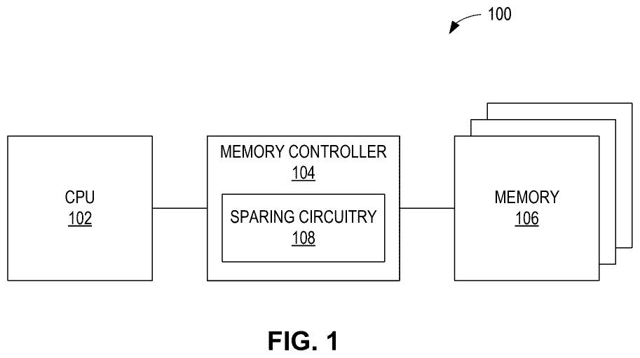

FIG. 1 is a block diagram of an example environment 100 in which an example memory controller 104 operates to move elements of memory. The example environment 100 includes an example central processing unit (CPU) 102, the example memory controller 104, and example memory 106.

The example CPU 102 is implemented by one or more central processing units of a computing system. Alternatively, the CPU 102 may implemented by any other type of logic circuitry, programmable circuitry, etc.

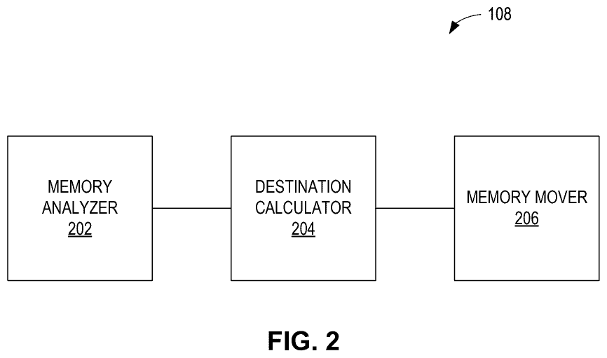

The memory controller 104 of the illustrated example couples the CPU 102 to the memory 106 and manages the memory 106. The memory controller 104 includes example sparing circuitry 108 to perform memory sparing or any other type of memory movement. An example implementation of the sparing circuitry 108 is described in conjunction with FIG. 2.

The memory 106 of the illustrated example is high bandwidth memory 3 (HBM3). Alternatively, the memory 106 may be any other type of memory such as double data rate memory (DDR), graphics DDR (GDDR) memory, low power double data rate (LPDDR) memory, HBM2 memory, HBM2e memory, etc.

FIG. 2 is a block diagram of an example implementation of the sparing circuitry 108 of FIG. 1 to move elements in memory (e.g., sparing). The sparing circuitry 108 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the sparing circuitry 108 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example sparing circuitry 108 includes an example memory analyzer circuitry 202, an example destination calculator circuitry 204, and example memory mover circuitry 206.

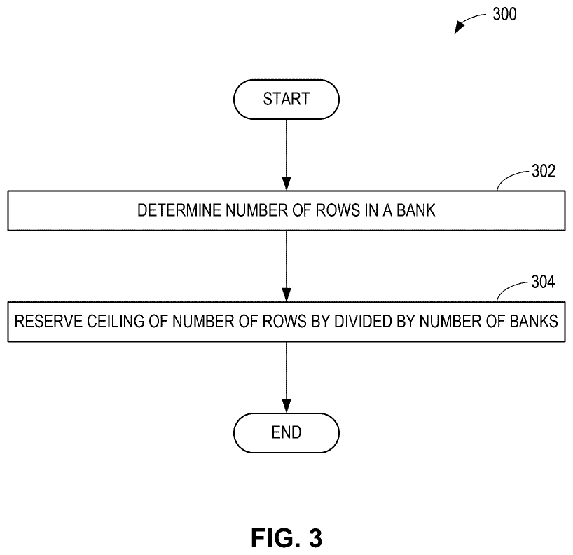

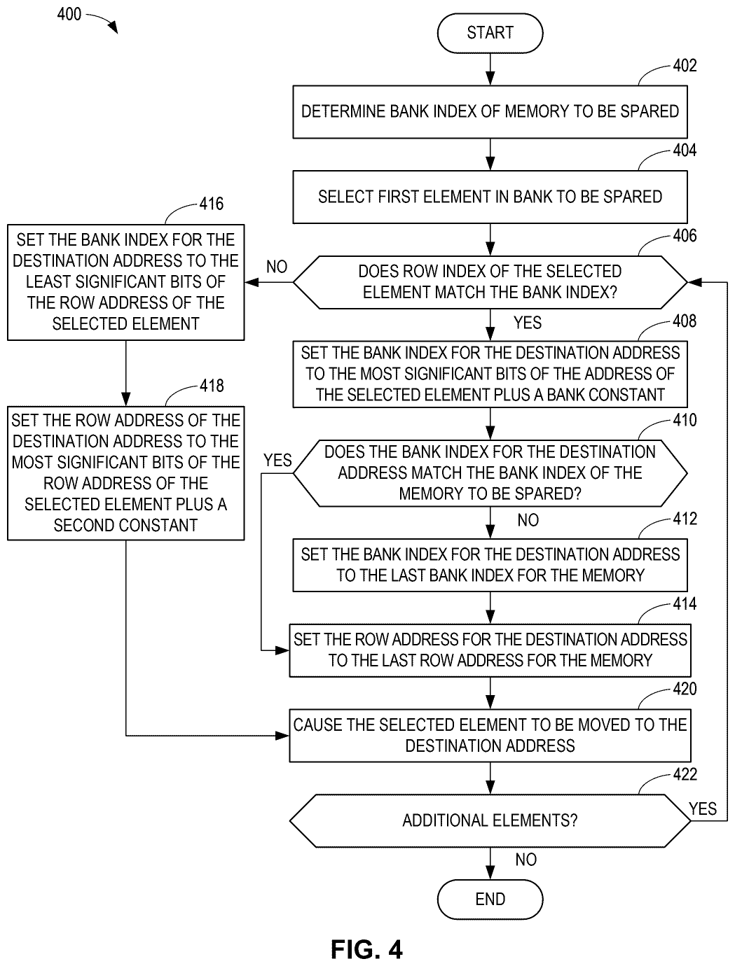

The memory analyzer circuitry 202 of the illustrated example analyzes the memory 106 to determine the memory size, layout, etc. In addition, the memory analyzer circuitry 202 analyzes the memory to determine locations of faulty memory (e.g., by detecting errors during reading and writing of the memory 106). In some examples, the memory analyzer circuitry 202 is instantiated by programmable circuitry executing memory analyzer instructions and/or configured to perform operations such as those represented by the flowchart(s) of FIGS. 3-4.

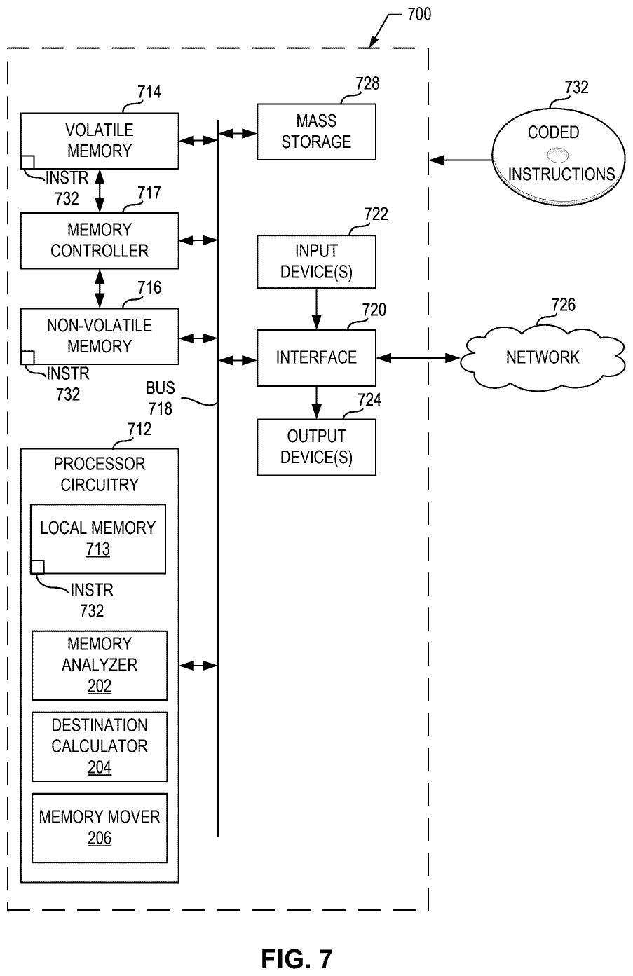

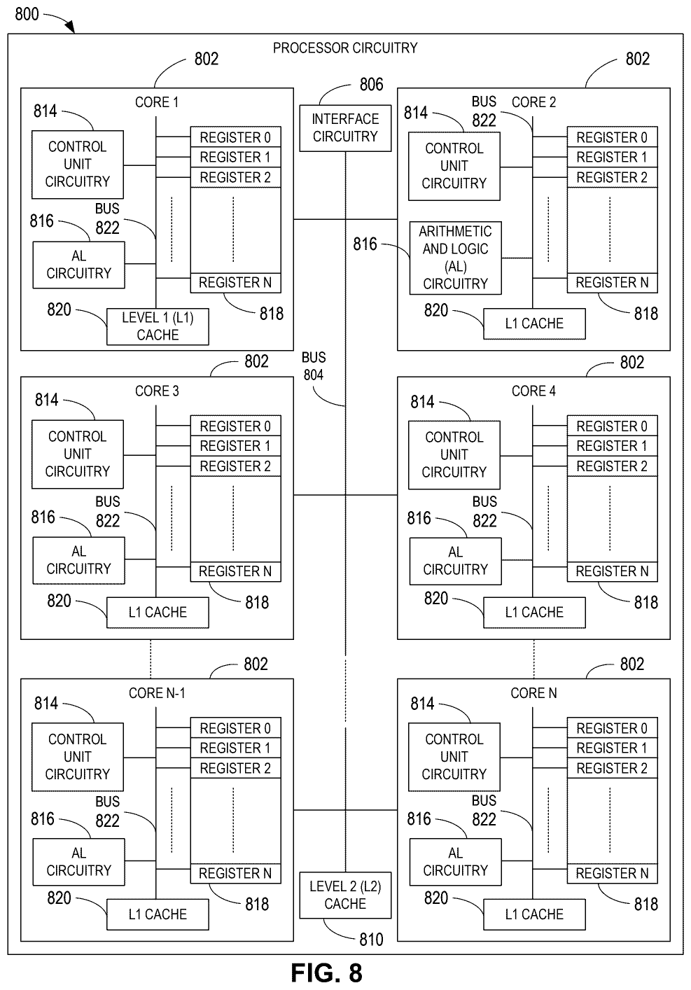

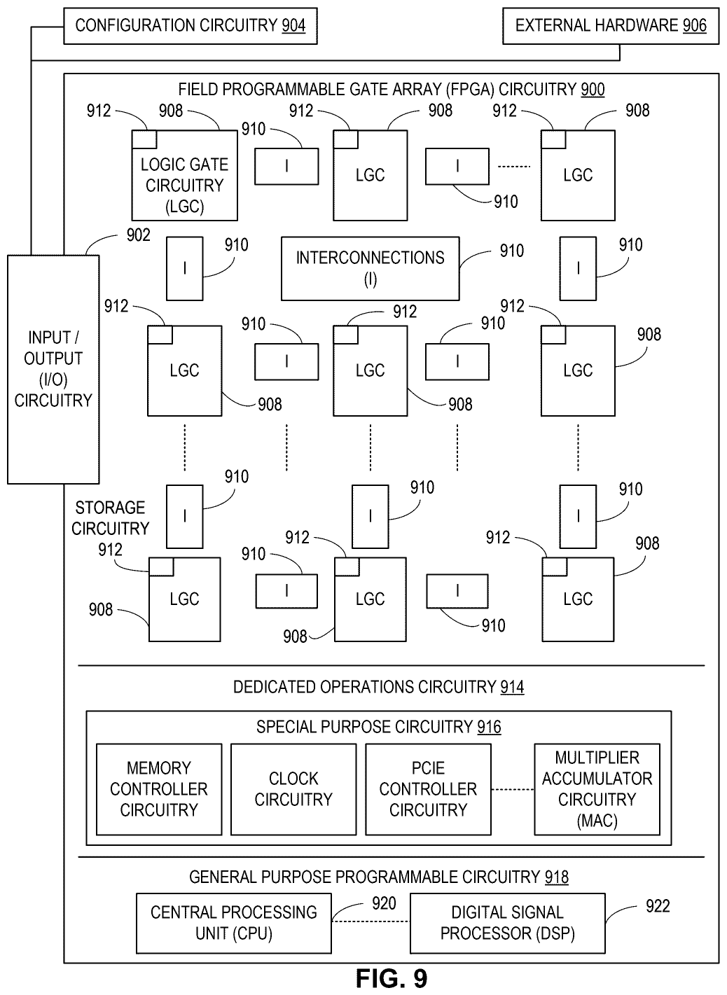

In some examples, the sparing circuitry 108 includes means for memory analysis. For example, the means for memory analysis may be implemented by the memory analyzer circuitry 202. In some examples, the memory analyzer circuitry 202 may be instantiated by programmable circuitry such as the example programmable circuitry 712 of FIG. 7. For instance, the memory analyzer circuitry 202 may be instantiated by the example microprocessor 800 of FIG. 8 executing machine executable instructions such as those implemented by at least blocks 302 and 304 of FIGS. 3 and 402 and 404 of FIG. 4. In some examples, the memory analyzer circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the memory analyzer circuitry 202 may be instantiated by any other combination of hardware, software, and/or firmware. For example, the memory analyzer circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example destination calculator circuitry 204 utilizes comparisons, if/else decisions, and addition to calculate a destination address for a memory element based on the original memory address. In some examples, the destination calculator circuitry 204 is instantiated by programmable circuitry executing memory analyzer instructions and/or configured to perform operations such as those represented by the flowchart(s) of FIGS. 3-4.

In some examples, the sparing circuitry 108 includes means for destination calculation. For example, the means for destination calculation may be implemented by the destination calculator circuitry 204. In some examples, the destination calculator circuitry 204 may be instantiated by programmable circuitry such as the example programmable circuitry 712 of FIG. 7. For instance, the destination calculator circuitry 204 may be instantiated by the example microprocessor 800 of FIG. 8 executing machine executable instructions such as those implemented by at least blocks 406-418 of FIG. 4. In some examples, the destination calculator circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the destination calculator circuitry 204 may be instantiated by any other combination of hardware, software, and/or firmware. For example, the destination calculator circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example memory mover circuitry 206 moves elements of memory from an original location (e.g., a location that is part of a portion of memory determined to be faulty) to a destination address calculated by the destination calculator circuitry 204. In some examples, the memory mover circuitry 206 is instantiated by programmable circuitry executing memory analyzer instructions and/or configured to perform operations such as those represented by the flowchart(s) of FIGS. 3-4.

In some examples, the sparing circuitry 108 includes means for memory movement. For example, the means for memory movement may be implemented by the memory mover circuitry 206. In some examples, the memory mover circuitry 206 may be instantiated by programmable circuitry such as the example programmable circuitry 712 of FIG. 7. For instance, the memory mover circuitry 206 may be instantiated by the example microprocessor 800 of FIG. 8 executing machine executable instructions such as those implemented by at least block 420 of FIG. 4. In some examples, the memory mover circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the memory mover circuitry 206 may be instantiated by any other combination of hardware, software, and/or firmware. For example, the memory mover circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the sparing circuitry 108 of FIG. 1 is illustrated in FIG. 2, one or more of the elements, processes, and/or devices illustrated in FIG. 2 may be combined, divided, re-arranged, omitted, eliminated, and/or implemented in any other way. Further, the memory analyzer circuitry 202, the example destination calculator circuitry 204, the example memory mover circuitry 206, and/or, more generally, the example sparing circuitry 108 of FIG. 2, may be implemented by hardware alone or by hardware in combination with software and/or firmware. Thus, for example, any of the memory analyzer circuitry 202, the example destination calculator circuitry 204, the example memory mover circuitry 206, and/or, more generally, the example sparing circuitry 108, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example sparing circuitry 108 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the sparing circuitry 108 of FIG. 2 and/or representative of example operations which may be performed by programmable circuitry to implement and/or instantiate the sparing circuitry 108 of FIG. 2, are shown in FIGS. 3-4. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-4, many other methods of implementing the example sparing circuitry 108 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 3-4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to reserve an area for memory sparing. The example machine-readable instructions and/or the example operations 300 of FIG. 3 begin at block 302, at which the memory analyzer 202 determines a number of rows in a bank of memory (e.g., in each bank of a plurality of banks) (block 302). The example memory analyzer 202 then reserves a ceiling of the number of rows divided by a number of columns (e.g., bank indices) in the memory (block 304). For example, if the memory has 96 rows and 32 columns, the memory analyzer 202 will reserve ceil

$$( \frac{96}{32} )$$

=3 of the last rows of the memory for sparing. Alternatively, the memory analyzer 202 may reserve another memory location. For example, the memory analyzer 202 may reserve the first rows of memory, rows in the middle of the memory, one row in multiple different banks of memory (e.g., one row in each of 3 different banks of memory), etc.

After reserving the memory, the process 300 of FIG. 3 ends. The process of FIG. 3 may be performed each time a computing system is booted, once upon the first boot of the computing system, each time the memory configuration is changed, etc.

FIG. 4 is a flowchart representative of example machine readable instructions and/or example operations 400 that may be executed, instantiated, and/or performed by programmable circuitry to move/relocate memory element (e.g., for memory sparing). The example machine-readable instructions and/or the example operations 400 of FIG. 4 begin at block 402, at which the memory analyzer 202 determines a bank index (e.g., column identifier) of memory to be spared/moved/relocated (block 402). For example, the memory analyzer 202 may determine a memory fault (e.g., based on a number of errors meeting a threshold), may receive a notification of a memory fault, may receive another type of notification that memory is to be relocated, etc.

The memory analyzer 202 selects the first element in the identified bank to be spared (block 404). For example, the memory analyzer 202 may select the element at the first row in a column to be spared. The destination calculator 204 then determines if a row index of the selected element matches the bank index of the memory to be spared (e.g., the row index can be mapped to the bank index using a hash function to generate a row index hash to determine if a collision is present) (block 406). For example, the destination calculator 204 may compare the least significant bits of a row address to the bank index to determine if they match (e.g., row 42 in binary is 101010 and the least four significant bits 1010 will match the bank index for column 10 (001010. In other words, the destination calculator 204 determines if using the least significant bits of the row address as the bank index for the destination address will result in a destination address that falls in the column of memory to be spared. For example, all row indices that are congruent modulo 32 with the bank index may be determined to match the bank index and follow the path of YES for block 406. The particular values that will report YES for block 406 may depend on the technique used for converting the row index to a bank index (e.g., if the least significant five bits of the row index will be utilized to determine the bank index, then the least significant five bits will be compared with the bank index of the memory to be spared in block 406).

If the destination calculator 204 determines that the row index of the selected element matches the bank index to be spared (block 406), the destination calculator 204 sets the bank index for the destination address to the most significant bits of the address of the selected element plus a bank constant (block 408). For example, the bank constant may be the number of bank indices/columns minus the number of rows of memory reserved (e.g., for memory with 96 rows and 32 columns, 3 rows are reserved and there will be three memory elements that will need to be moved from a destination address that falls in the bank index to be spared and they will be placed in the last three cells of the last row of the reserved memory). Of course, other arrangements and constants may be used (e.g., the cells that would be placed in the bank index to be spared could be placed in another row and/or in another place in the row (e.g., at the beginning of the row))

Still in the “Yes” portion of the decision block 406, the destination calculator 204 then determines if the bank index for the destination address determined in block 408 matches the bank index of the memory to be spared (block 410). If the bank index for the destination address determined in block 408 matches the bank index of the memory to be spared (e.g., the memory would be stored in the column of memory that is to be spared), the destination calculator changes the bank index for the destination address to the last bank index for the memory (block 412). After updating the bank index or after determining “No” in block 410, the row address for the destination address is set to the last row address for the memory (block 414). Control then proceeds to block 420, which will be described below.

Returning to block 406, when the destination calculator 204 determines that the row index of the selected element does not match the bank index, the destination calculator 204 sets the bank index for the destination address to the least significant bits of the row address of the selected element (block 416). The destination calculator 204 then sets the row address of the destination address to the most significant bits of the row address of the selected element plus a row constant (block 418). For example, the row constant may be determined as the number of rows in the memory minus the number of rows reserved for sparing (e.g., in a zero-based indexing system) (e.g., 96 rows of memory minus 3 rows reserved provides a row constant of 93). Control then proceeds to block 420.

After block 414 or block 418, the memory mover circuitry 206 moves the selected element of memory to the destination address (block 420). For example, the memory mover circuitry 206 may move the memory element and store a lookup table, algorithm, formula, etc. to enable the memory controller 104 to retrieve/write the element at the destination location when the CPU 102 requests to retrieve/write the element using the original location.

The memory analyzer circuitry 202 then determines if there are additional elements to be analyzed (block 422). When there are additional elements to be analyzed the memory analyzer circuitry 202 selects the next element and control returns to block 406 to process that next element move. For example, the memory analyzer circuitry 202 may iterate over all of the elements in the column of memory that has been identified for sparing.

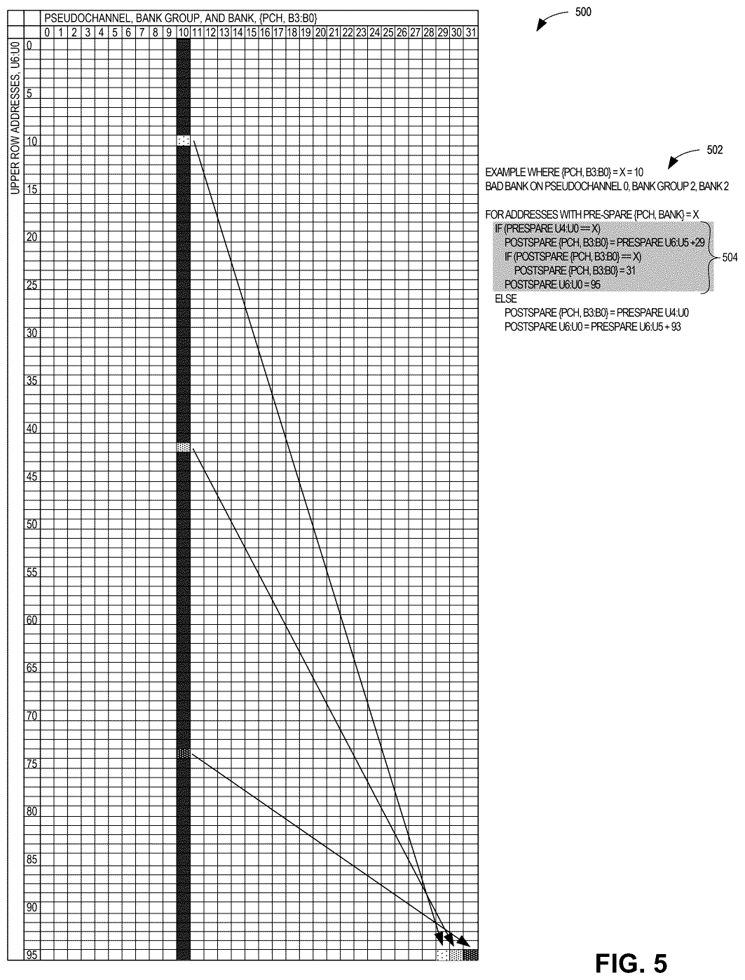

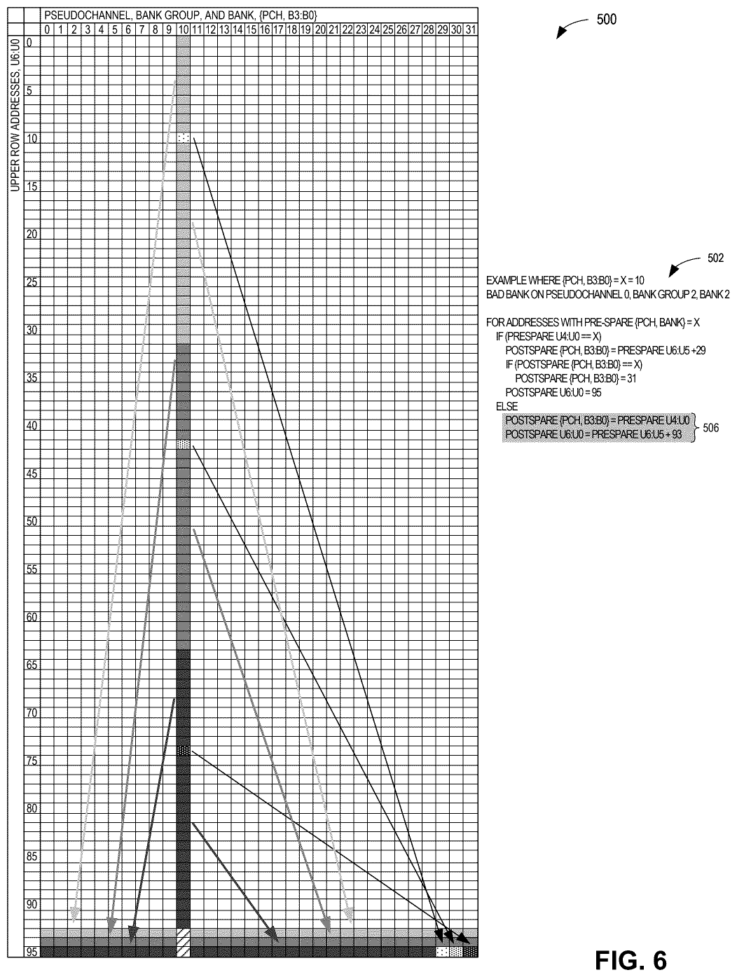

FIGS. 5-6 illustrate an example movement of elements in memory 500 that may be performed/caused by the sparing circuitry of FIG. 2. FIGS. 5 and 6 include example pseudocode 502 illustrating the operations that may be performed (e.g., by the sparing circuitry 108). FIG. 5 illustrates the destination addresses calculated for addresses that meet the IF statement in portion 504 of the pseudocode 502. FIG. 6 illustrates the destination addresses calculated for addresses that do not meet the IF statement and are calculated in portion 506 of the pseudocode 502. The example movements are meant to illustrate an example approach for movement within a memory having the dimensions illustrated. In other implementations having different memory size, the movements may be modified and the constants in the pseudocode may be adjusted to be consistent with the memory size.

FIG. 7 is a block diagram of an example programmable circuitry platform 700 structured to execute and/or instantiate the example machine-readable instructions and/or the example operations of FIGS. 3-4 to implement the sparing circuitry 108 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, VPUs, DSPs, and/or microcontrollers from any desired family or manufacturer. The programmable circuitry 712 may be implemented by one or more semiconductor based (e.g., silicon based) devices. In this example, the programmable circuitry 712 implements the memory analyzer 202, the destination calculator 204, and the memory mover 206.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 3-4, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 3-4 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 3-4.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer-based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 3-4 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-4. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-4. As such, the FPGA circuitry 900 may be configured and/or structured to effectively instantiate some or all of the operations/functions corresponding to the machine readable instructions of the flowchart(s) of FIGS. 3-4 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 3-4 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), Verilog, or System Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, SystemC, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 3-4 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 3-4 to perform first operation(s)/function(s), the FPGA circuitry 900 of FIG. 9 may be configured and/or structured to perform second operation(s)/function(s) corresponding to a second portion of the machine readable instructions represented by the flowcharts of FIG. 3-4, and/or an ASIC may be configured and/or structured to perform third operation(s)/function(s) corresponding to a third portion of the machine readable instructions represented by the flowcharts of FIGS. 3-4.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

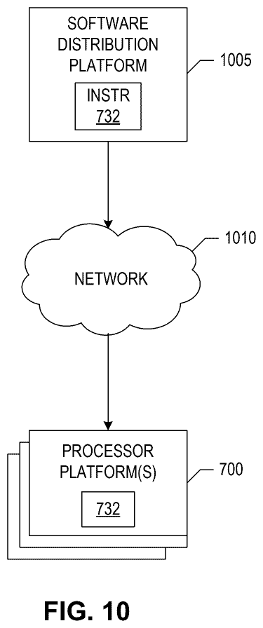

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 3-4, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 3-4, may be downloaded to the example programmable circuitry platform 700, which is to execute the machine readable instructions 732 to implement the sparing circuitry 108. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that can be perform memory movement/sparing more efficiently than prior techniques (e.g., by utilizing IF/THEN/ELSE logic instead of instead of more complex operations like multiply and divide (which would require more logic gates to implement). Disclosed systems, apparatus, articles of manufacture, and methods improve the efficiency of using a computing device by increasing the efficiency of memory sparing operations. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to methods and apparatus to manage memory movement are disclosed herein. Further examples and combinations thereof include the following:

Example 1 includes a memory controller comprising first logic circuitry to determine a first bank index for a bank of a memory that is to be moved, and determine if a first row index hash of an element in the bank of memory matches the first bank index, and second logic circuitry to when the first row index hash matches the first bank index, move the element to a reserved row of the memory in the memory based on the first row index, and when the first row index hash does not match the first bank index, move the element to a bank in the reserved row that has a second bank index based on the first row index.

Example 2 includes the memory controller of example 1, wherein the memory controller is coupled to memory.

Example 3 includes the memory controller of one of examples 1-2, further comprising third logic circuitry to allocate the reserved row to memory sparing.

Example 4 includes the memory controller of one of examples 1-3, wherein, when the first row index hash does not match the first bank index, the second logic circuitry is to move the element to select a destination row from among a plurality of rows based on the first row index.

Example 5 includes the memory controller of one of examples 1-4, wherein, when the first row index hash matches the first bank index, the first logic circuitry is to determine a second bank index in the reserved row by adding a constant to a most significant bits of the first row index.

Example 6 includes the memory controller of example 5, wherein the constant is equal to a largest bank index of the memory minus a ceiling of a number of rows of the memory divided by a number of banks of the memory.

Example 7 includes the memory controller of one of examples 1-5, wherein the first logic circuitry is to determine that an error threshold has been met for the bank of the memory that is to be moved.

Example 8 includes the memory controller of one of examples 1-6, wherein the second logic circuitry is to mark the bank of the memory that is to be moved as failed.

Example 9 includes a non-transitory machine readable storage medium comprising instructions to cause programmable circuitry to at least determine a first bank index for a bank of a memory that is to be moved, determine if a first row index hash of an element in the bank of memory matches the first bank index, when the first row index hash matches the first bank index, move the element to a reserved row in the memory based on the first row index, and when the first row index hash does not match the first bank index, move the element to a bank in the reserved row that has a second bank index based on the first row index.

Example 10 includes the non-transitory machine readable storage medium controller of example 9, wherein the memory controller is coupled to memory.

Example 11 includes the non-transitory machine readable storage medium controller of one of examples 9-10, further comprising third logic circuitry to allocate the reserved row to memory sparing.

Example 12 includes the non-transitory machine readable storage medium controller of one of examples 9-11, wherein, when the first row index hash does not match the first bank index, the programmable circuitry is to move the element to select a destination row from among a plurality of rows based on the first row index.

Example 13 includes the non-transitory machine readable storage medium controller of one of examples 9-12, wherein, when the first row index hash matches the first bank index, the programmable circuitry is to determine a second bank index in the reserved row by adding a constant to a most significant bits of the first row index.

Example 14 includes the non-transitory machine readable storage medium controller of example 13, wherein the constant is equal to a largest bank index of the memory minus a ceiling of a number of rows of the memory divided by a number of banks of the memory.

Example 15 includes the non-transitory machine readable storage medium controller of one of examples 9-14, wherein the programmable circuitry is to determine that an error threshold has been met for the bank of the memory that is to be moved.

Example 16 includes the non-transitory machine readable storage medium controller of one of examples 9-15, wherein the programmable circuitry is to mark the bank of the memory that is to be moved as failed.

Example 17 includes a memory controller comprising first logic circuitry to determine a first bank index for a bank of a memory that is to be moved, and determine if a plurality of least significant bits of an upper portion of an address of an element in the bank of memory matches the first bank index, and second logic circuitry to when the plurality of least significant bits match the first bank index, move the element to a destination location that has a bank index equal to a plurality of most significant bits of the upper portion of the address plus an offset, and when the plurality of least significant bits do not match the first bank index, move the element to a destination location that has a bank index equal to the least significant bits of an upper portion of the address.

Example 18 includes the memory controller of example 17, wherein the memory controller is coupled to memory.

Example 19 includes the memory controller of one of examples 17-18, further comprising third logic circuitry to allocate the destination location for memory sparing.

Example 20 includes the memory controller of one of examples 17-19, wherein, when the plurality of least significant bits do not match the first bank index, the second logic circuitry is to move the element to a destination row from among a plurality of rows based on the plurality of most significant bits.

Example 21 includes a method to be performed by an apparatus executing the instructions of any of the foregoing examples.

Example 22 includes a method comprising determining a first bank index for a bank of a memory that is to be moved, determining if a first row index hash of an element in the bank of memory matches the first bank index, when the first row index matches the first bank index, moving the element to a reserved row in the memory based on the first row index, and when the first row index hash does not match the first bank index, moving the element to a bank in the reserved row that has a second bank index based on the first row index.

Example 23 includes the method of example 22, further comprising allocating the reserved row to memory sparing.

Example 24 includes the method of one of examples 22-23, wherein, when the first row index hash does not match the first bank index, further comprising moving the element to select a destination row from among a plurality of rows based on the first row index.

Example 25 includes the method of one of examples 22-24, wherein, when the first row index hash matches the first bank index, the programmable circuitry is to determine a second bank index in the reserved row by adding a constant to a most significant bits of the first row index.

Example 26 includes the method of example 25, wherein the constant is equal to a largest bank index of the memory minus a ceiling of a number of rows of the memory divided by a number of banks of the memory.

Example 27 includes the method of one of examples 22-26, further comprising determining that an error threshold has been met for the bank of the memory that is to be moved.

Example 28 includes the method of one of examples 22-27, further comprising marking the bank of the memory that is to be moved as failed.

Example 22 includes an apparatus to perform the method of any of examples 22-example 28 includes

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A memory controller comprising:
first logic circuitry to:
determine a first bank index for a bank of a memory that is to be moved; and
determine if a first row index hash of an element in the bank of memory matches the first bank index; and
second logic circuitry to:
when the first row index hash matches the first bank index, move the element to a reserved row of the memory in the memory based on the first row index; and
when the first row index hash does not match the first bank index, move the element to a bank in the reserved row that has a second bank index based on the first row index.

2. The memory controller of claim 1, wherein the memory controller is coupled to memory.

3. The memory controller of claim 1, further comprising third logic circuitry to allocate the reserved row to memory sparing.

4. The memory controller of claim 1, wherein, when the first row index hash does not match the first bank index, the second logic circuitry is to move the element to select a destination row from among a plurality of rows based on the first row index.

5. The memory controller of claim 1, wherein, when the first row index hash matches the first bank index, the first logic circuitry is to determine a second bank index in the reserved row by adding a constant to a most significant bits of the first row index.

6. The memory controller of claim 5, wherein the constant is equal to a largest bank index of the memory minus a ceiling of a number of rows of the memory divided by a number of banks of the memory.

7. The memory controller of claim 1, wherein the first logic circuitry is to determine that an error threshold has been met for the bank of the memory that is to be moved.

8. The memory controller of claim 1, wherein the second logic circuitry is to mark the bank of the memory that is to be moved as failed.

9. A non-transitory machine readable storage medium comprising instructions to cause programmable circuitry to at least:
determine a first bank index for a bank of a memory that is to be moved;
determine if a first row index hash of an element in the bank of memory matches the first bank index;
when the first row index hash matches the first bank index, move the element to a reserved row in the memory based on the first row index; and
when the first row index hash does not match the first bank index, move the element to a bank in the reserved row that has a second bank index based on the first row index.

10. The non-transitory machine readable storage medium controller of claim 9, wherein the memory controller is coupled to memory.

11. The non-transitory machine readable storage medium controller of claim 9, further comprising third logic circuitry to allocate the reserved row to memory sparing.

12. The non-transitory machine readable storage medium controller of claim 9, wherein, when the first row index has does not match the first bank index, the programmable circuitry is to move the element to select a destination row from among a plurality of rows based on the first row index.

13. The non-transitory machine readable storage medium controller of claim 9, wherein, when the first row index hash matches the first bank index, the programmable circuitry is to determine a second bank index in the reserved row by adding a constant to a most significant bits of the first row index.

14. The non-transitory machine readable storage medium controller of claim 13, wherein the constant is equal to a largest bank index of the memory minus a ceiling of a number of rows of the memory divided by a number of banks of the memory.

15. The non-transitory machine readable storage medium controller of claim 9, wherein the programmable circuitry is to determine that an error threshold has been met for the bank of the memory that is to be moved.

16. The non-transitory machine readable storage medium controller of claim 9, wherein the programmable circuitry is to mark the bank of the memory that is to be moved as failed.

17. A memory controller comprising:
first logic circuitry to:
determine a first bank index for a bank of a memory that is to be moved; and
determine if a plurality of least significant bits of an upper portion of an address of an element in the bank of memory matches the first bank index; and
second logic circuitry to:
when the plurality of least significant bits match the first bank index, move the element to a destination location that has a bank index equal to a plurality of most significant bits of the upper portion of the address plus an offset; and
when the plurality of least significant bits do not match the first bank index, move the element to a destination location that has a bank index equal to the least significant bits of an upper portion of the address.

18. The memory controller of claim 17, wherein the memory controller is coupled to memory.

19. The memory controller of claim 17, further comprising third logic circuitry to allocate the destination location for memory sparing.

20. The memory controller of claim 17, wherein, when the plurality of least significant bits do not match the first bank index, the second logic circuitry is to move the element to a destination row from among a plurality of rows based on the plurality of most significant bits.
